(19) United States
(12) Patent Application Publication
(10) Pub. No.: US 2008/0232537 A1
(43) Pub. Date: Sep. 25, 2008

(54) NUCLEAR FUEL ASSEMBLY WITH AN ADVANCED SPACER GRID

(76) Inventors: Adolfo Reparaz, Columbia, SC (US); David M. McCreary, Columbia, SC (US)

Correspondence Address: WESTINGHOUSE ELECTRIC COMPANY, LLC, P.O. BOX 355, PITTSBURGH, PA, 15230-0355, US

(21) Appl. No.: 11/687,807

(22) Filed: Mar. 19, 2007

(51) Int. Cl. G21C 3/34

(52) U.S. Cl. 376/438

(57) ABSTRACT

An improved nuclear fuel assembly having elongated grid straps curved in a substantially undulating wave pattern along their axial length and interleaved together to form an egg-crate configuration having a plurality of roughly square cells that support fuel rods and guide tube thimbles. The cells that support fuel rods have their outer walls curved outward to increase the contact area around the fuel rod cladding The interior straps are on a diagonal with regard to a peripheral strap and at least one cell adjacent each fuel rod cell is left empty for the unobstructed flow of coolant. Additional coolant mixing devices can be added to the empty cells. The walls of each fuel rod cell are devoid of dimples and, in one embodiment, springs.

### BACKGROUND OF THE INVENTION

1. Field of the Invention

The present invention relates generally to nuclear reactors, and more particularly, to a pressurized water nuclear reactor having a fuel assembly with an improved grid.

2. Description of the Related Art

In most pressurized water nuclear reactors (PWR), the reactor core is comprised of a large number of elongated fuel assemblies. These fuel assemblies typically include a plurality of fuel rods held in an organized array by a plurality of grids spaced axially along the fuel assembly length and attached to a plurality of elongated thimble tubes of the fuel assembly. The thimble tubes typically receive control rods or instrumentation therein. Top and bottom nozzles are on opposite ends of the fuel assembly and are secured to the ends of the thimble tubes that extend slightly above and below the ends of the fuel rods.

The grids, as is known in the relevant art, are used to precisely maintain the spacing and support between the fuel rods in the reactor core, provide lateral support for the fuel rods and induce mixing the coolant. One type of conventional grid design includes a plurality of interleaved straps that together form an egg-crate configuration having a plurality of roughly square cells which individually accept the fuel rods therein. Depending upon the configuration of the thimble tubes, the thimble tubes can either be received in cells that are sized the same as those that receive fuel rods therein, or in relatively larger thimble cells defined in the interleaved straps. The interleaved straps provide attachment points to the thimble tubes, thus enabling their positioning at spaced locations along the length of the fuel assembly.

The straps are configured such that the cells through which the fuel rods pass each include one or more relatively compliant springs and a plurality of relatively rigid dimples. The springs and dimples may be formed in the metal of the interleaved straps and protrude outwardly therefrom into the cells through which the fuel rods pass. The springs and dimples of each fuel rod cell then contact the corresponding fuel rod extending through the cell. Outer straps of the grid are attached together and peripherally enclose the inner straps of the grid to impart strength and rigidity to the grid and define individual fuel rod cells around the perimeter of the grid. The inner welded or brazed to the peripheral or outer straps defining the outer perimeter of the assembly.

At the individual cell level, the fuel rod support is normally provided by the combination of rigid support dimples and flexible springs as mentioned above. There are many variations to the spring-dimple support geometry that have been used or are currently in use, including diagonal springs, “I” shaped springs, cantilevered springs, horizontal and vertical dimples, etc. The number of springs per cell also varies. The typical arrangement it two springs and four dimples per cell. The geometry of the dimples and springs needs to be carefully determined to provide adequate rod support through the life of the assembly.

During irradiation, the initial spring force relaxes more or less rapidly, depending on the spring material and irradiation environment. The cladding diameter also changes as a result of the very high coolant pressure and operating temperatures and the fuel pellets inside the rod also change their diameter by densification and swelling. The outside cladding diameter also increases, due to the formation of an oxide layer. As a result of these dimensional and material property changes, maintaining adequate rod support through the life of a fuel assembly is very challenging.

Under the effect of axial flow and crossflow induced by thermal and pressure gradients within the reactor and other flow disturbances, such as standing waves and eddies, the fuel rods, which are slender bodies, are continuously vibrating with relatively small amplitudes. If the road is not properly supported, this very small vibration amplitude may lead to relative motion between the support points and the cladding. If the pressure exerted by the sliding rod on the relatively small dimple and grid support surfaces is high enough, the small corrosion layer on the surface of the cladding can be removed by abrasion, exposing the base metal to the coolant. As a new corrosion layer is formed on the exposed fresh cladding surface, it is also removed by abrasion until ultimately the wall of the rod is perforated. This phenomenon is known as corrosion fretting and in 2006 it was the leading cause of fuel failures in PWR reactors.

Support grids also provide another important function in the assembly, that of coolant mixing to decrease the maximum coolant temperature. Since the heat generated by each rod is not uniform, there are thermal gradients in the coolant. One important parameter in the design of the fuel assemblies is to maintain efficient heat transfer from the rods to the coolant. The higher the amount of heat removed per unit time, the higher the power being generated. At high enough coolant temperatures, the rate of heat that can be removed per unit of cladding are in a given time decreases abruptly in a significant way. This phenomenon is known as deviation from nucleate boiling or DNB. If within the parameters of reactor operation, the coolant temperature were to reach the point of DNB, the cladding surface temperature would increase rapidly in order to evacuate the heat generated inside the rod and rapid cladding oxidation would lead to cladding failure. It is clear the DNB needs to be avoided to prevent fuel failures. Since DNB, if it occurs, takes place at the point where the coolant is at its maximum temperature, it follows that decreasing the maximum coolant temperature by coolant mixing within the assembly permits the generation of larger amounts of power without reaching DNB conditions. Normally, the improved mixing is achieved by using mixing vanes in the downflow side of the grid structure. The effectiveness of mixing is depending upon the shape, size and location of the mixing vanes relative to the fuel rod.

Other important functions of the grid include the ability to sustain handling and normal operation at anticipated accident loads without losing function and to avoid “hot spots” on the fuel rods due to the formation of steam pockets between the fuel rods and the support points, which may result when not enough coolant is locally available to evacuate the heat generated in the rod. Steam pockets cause overheating of the fuel rod to the point of failure by rapid localized corrosion of the cladding.

Maintaining a substantially balanced coolant flow through the fuel assemblies across the core is a desirable objective to maintain substantially uniform heat transfer. Any changes in fuel assembly design can alter the pressure drop and affect the relative balance in flow resistance through the core among the various types of fuel assemblies. Changes in grid design that reduce pressure drop are desirable because such changes enable a fuel assembly designed to introduce other improvements that will restore the pressure drop equilibrium among fuel assemblies.

It is thus desired to provide an improved grid that exhibits better heat transfer, improved fuel rod support and reduced pressure drop. It is a further object of this invention to provide such an improved grid that is less expensive to manufacture than conventional designs.

### SUMMARY OF THE INVENTION

The foregoing objectives are achieved by an improved nuclear fuel assembly grid having a first plurality of spaced, parallel, elongated straps with each strap curved in a substantially undulating wave pattern (defined hereafter) along its axial length. A second plurality of spaced, parallel, elongated straps are similarly curved in a substantially undulating wave pattern along their axial lengths. The first and second plurality of spaced, parallel, elongated straps are positioned orthogonal to each other and aligned in a regular pattern so that the intersections of each adjacent four straps define a cell, some of which support fuel rods. Preferably, the straps are interleaved at their intersections in an egg-crate pattern. A bordering strap surrounds the exterior perimeter of the first and second plurality of spaced, parallel, elongated straps and is affixed at the intersections with the interior straps. Preferably, the interior straps are aligned so that all of the undulations bordering each cell either curve toward the center of the cell or all curve a way from the center of the cell. Preferably, a plurality of the cells that have bordering undulations curving away from the center of the cell support fuel rods. The bottom or top of at least some of the straps bordering cells supporting fuel rods are splayed to promote coolant mixing. In one embodiment, the straps bordering the cells supporting the fuel rods have no raised dimples or springs.

In one preferred embodiment, the cells adjacent to each cell supporting a fuel rod are empty in which the unobstructed flow of coolant can occur. Preferably, the straps are on a diagonal with the bordering strap and at least some of the straps in each of the first and second plurality of spaced, parallel, elongated straps are of different lengths.

In a second embodiment of the invention, the hard dimples employed by the prior art to support the rods are eliminated and eight appropriately shaped cantilevered springs on each rod cell are provided. Each of the springs provides a relatively large line of contact with a fuel rod to provide an adequate force with low contact pressure, rod support through life. The low contact pressure is not enough to cause generalized removal of the oxide layer by abrasion, even when due to dimensional changes or small relative movement between the rod and the support points. Desirably, two cantilevered springs are provided per side of each fuel rod cell. The shape of each of the cantilevered springs is such that when a uniform pressure is applied which corresponds to the contact pressure with the fuel rod, the spring surface is in theoretical contact with the rod along a vertical line parallel to the axis of the fuel rod. This requires that the undeflected spring is slightly curved along its length. In the compressed condition, the spring area where the rod contact takes place is bent around a vertical bend line along the full lengths of the spring and way from the surface of the rod, so that the rod is in contact with two essentially convex surfaces per side defining two narrow lines of contact. The leading edge of the springs is further sent away around a horizontal bend line which, along with the vertical b end line, for a three-dimensional curved quasi-spherical surface. Desirably, to control the stiffness of the spring, shallow elongated horizontal indentations may be stamped on the straps extending along a portion of the length of the springs to add to the springs stiffness or vertical slots may be incorporated where a reduction in spring stiffness is required.

In another embodiment, conventional mixing vanes can be used within the vicinity of each fuel rod. The mixing vanes, positioned at the intersection of the straps, preferably have a small hole to allow welding of the strap intersection. In another embodiment and in addition to or instead of conventional mixing vanes at at least some of the strap intersection surrounding each rod, the strap configuration of this invention allows insertion of additional mixing devices, such as twisted ribbon inserts, inside the open cells between fuel rod cells. The ribbons are welded in place inside the grid cells between rods.

### BRIEF DESCRIPTION OF THE DRAWINGS

A further understanding of the invention can be gained from the following description of the preferred embodiment when read in conjunction with the accompanying drawings in which:

FIG. 1 is a top plan view of a pressurized water reactor conventional fuel assembly grid;

FIG. 2 is a top plan view of a corner section of the improved fuel grid of this invention;

FIG. 3 is an elevational view, partly in section, of a fuel assembly which employs the fuel rod grid of the present invention, the assembly being illustrated din vertically foreshortened form with parts broken away for clarity;

FIG. 4 is a plan view of a signal fuel rod cell of this invention with two cantilevered springs on each side shown in phantom in their undeflected state;

FIG. 5 is a plan view of one strap cell wall showing the cantilevered springs in uncompressed form;

FIG. 6 is an elevational view of the cell wall of FIG. 5, providing a side view of the cantilevered springs;

FIG. 7 is a side view of a cantilevered spring showing the rounded edge of the cantilevered end of the spring;

FIG. 8 is a plan view of a single rod cell showing the cantilevered springs in compressed form with conventional mixing vanes at each of the rod intersections with small holes to provide access to weld the intersections;

FIG. 9 is a plan view of an untwisted ribbon vane;

FIG. 10 is a perspective view of a 90° twisted ribbon vane; and

FIG. 11 is a plan view of a corner section of a grid constructed in accordance with this invention with the ribbon vanes in place within the interior cells between fuel rods.

### DESCRIPTION OF THE PREFERRED EMBODIMENTS

Nuclear fuel spacer grids are used in fuel assemblies to position nuclear fuel rods. Accurately positioning nuclear fuel rods is critical to assure proper nuclear and thermo-hydraulic performance of the nuclear core of a reactor. An ideal nuclear fuel spacer grid should:

1. be simple and inexpensive to manufacture;

2. permit fuel rod reconstitution and easy loading of the fuel rods;

3. maintain fuel assembly geometry over the lifetime of the fuel assembly;

4. be of a lower pressure drop design, yet promote coolant mixing and heat transfer; and

5. be low neutron absorbers.

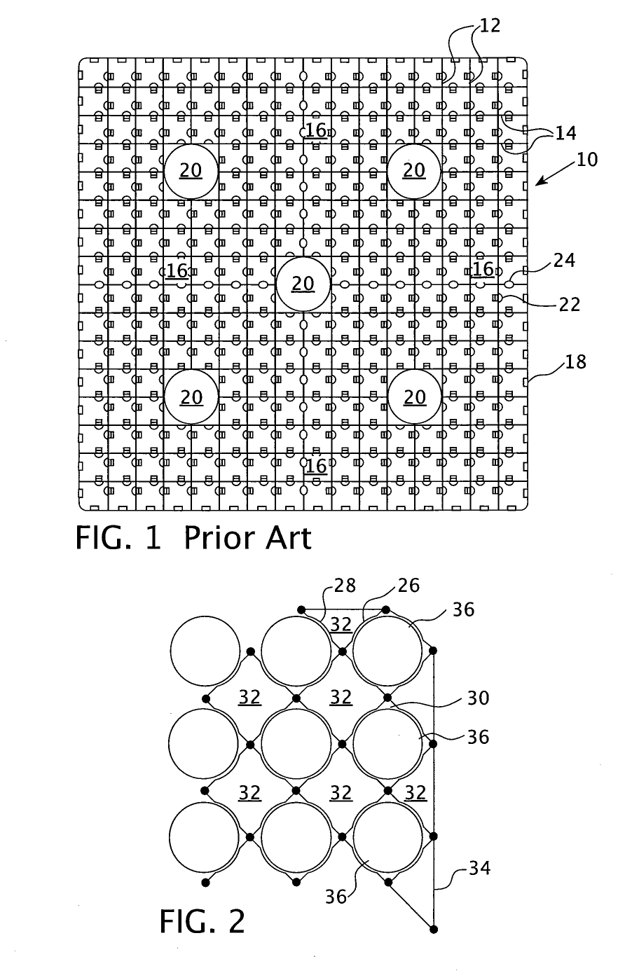

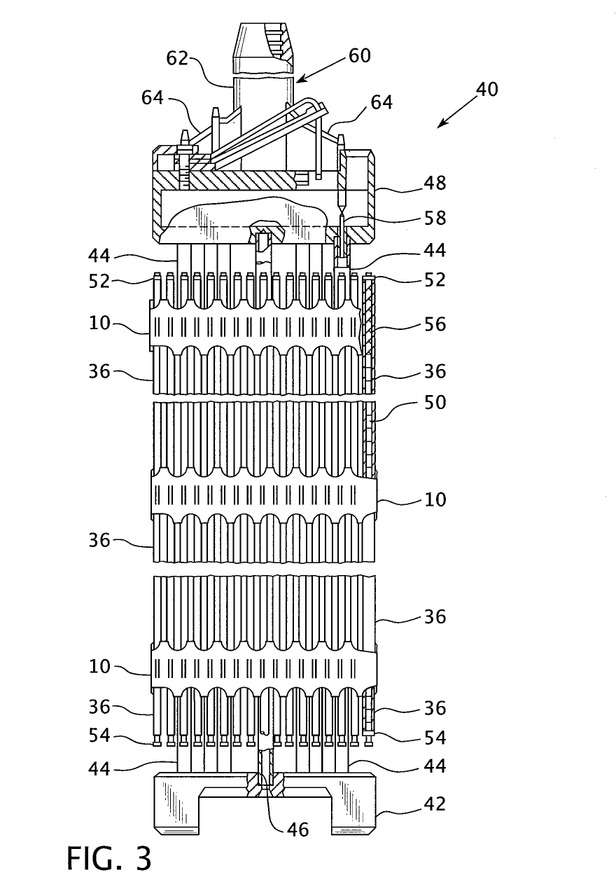

Many conventional spacer grids are composed of straight grid straps that are interleaved together to form an egg-crate configuration having a plurality of roughly square cells, many of which support the fuel rods. An example of such conventional fuel grid 10 can be found in FIG. 1. A spaced parallel array of grid straps 12 of equal length are positioned orthogonally to a second plurality of spaced, parallel grid straps 14 of equal length and are encircled by a border strap 18, with each of the straps being welded at their intersections. The cells 16 support the fuel rods while the cells 20 support guide tubes and an instrumentation tube. Because the fuel rods must maintain a spacing or pitch between each other, these straight grid straps 12 and 14 at the locations that border the cells 16 that support the fuel rods have springs 22 and/or dimples 24 that are stamped in the sides of the straps 12 and 14 to protrude into the cells 16 to contact the fuel rods and hold them firmly in position. The stamped features on the grid straps 12 and 14, i.e., the springs 22 and dimples 24, require costly tools to produce and require right tolerances. Furthermore, the grid straps 12 and 14 for a particular grid must be carefully assembled, paying attention to the orientation of the springs, dimples and/or mixing vanes. It is therefore desirable to eliminate the springs and dimples or modify their arrangement to simplify the construction process. However, an alternative method for precisely locating the fuel rods within a grid constructed from straight grid straps in the egg-crate configuration has not previously been found.

The nuclear fuel spacer grid design of this invention comprises a grid frame constructed out of substantially wavy or undulated straps 26, 28 preferably, in one embodiment, with no stamped springs or dimples as shown in FIG. 2. The phrase “substantially wavy or undulated straps” is not intended to imply that the straps are necessarily continuously cured in alternately opposite directions, but that at least a portion of each strap midway between adjacent intersecting straps is curved as illustrated in FIG. 2 and 11. Preferably the straps bordering fuel rod cells have a radius of curvature which is equal to or greater than the radius of the fuel rods. The plurality of straps 26 are spaced from each other and arranged orthogonally with the straps 28 to form the individual fuel cells 30. Each fuel cell 30 has an open cell 32 adjacent to it that provides an unobstructed path for the flow of coolant. The straps 26 and 28 are arranged on a diagonal pitch, i.e., a diagonal orientation with regard to an outer border strap 34. The wavy straps 36 and 28 are of varying length and preferably interlock together as in conventional interleaved grid designs with welds on the top and bottom of the grid strap intersections. Since the strap intersection of this design is in the rod gaps, i.e., the space between fuel rods 36,

As mentioned above, the fuel rods 36 and the array thereof in the assembly 40 are held in spaced relationship with one another by the grids 10 spaced along the fuel assembly lengths. Each fuel rod 36 includes nuclear fuel pellets 15 and the opposite ends of the rods are enclosed by upper and lower end plugs 52 and 54, to hermetically seal the rod. Commonly, a plenum spring 56 is disposed between the upper end plug 52 and the pellets 50 to maintain the pellets in a tight, stacked relationship within the rod 36. The fuel pellets 50 composed of fissile material are responsible for creating the reactive power of the PWR. A liquid moderator/coolant, such as water or water-containing boron, is pumped upwardly through the fuel assemblies of the core in order to extract heat generated therein for the production of useful work.

To control the fission process, a number of control rods 58 are reciprocally movable in the guide thimbles 44 located at pre-determined positions in the fuel assembly 40. Specifically, the top nozzle 48 has associated therewith a rod cluster control mechanism 60, having an internally threaded cylindrical member 62 with a plurality of radially-extending flukes or arms 65 such that the control mechanism 60 is operable to move the control rods 58 vertically in the guide thimbles 44 to thereby control the fission process in the fuel assembly 40, all in a well-known manner.

Thus, the advanced grid of this invention incorporated in a fuel assembly 40 provides a number of advantages. The symmetric geometry for each cell reduces assembly time, requires the same number of welds per grid as conventional designs and provides symmetric stiffness, load and deflection. Furthermore, doing away with the requirement of stamping a different arrangement of springs and/or dimples on adjacent cell walls reduces production time and cost of the grid straps and reduces grid strap scrap. Since there are no sharp edges due to springs or dimples, the fuel rod may be spiral-driven for loading/unloading from the fuel assembly, resulting in less surface scratching. In comparison to a conventional spacer grid, the projected area of the advanced grid of this invention is expected to have a pressure drop that is less than or equal to that of conventional spacer grids. Additionally, the large fuel rod contact area with the grid straps on all four sides increase the fuel rod fretting margin; because of the smaller pre-load than conventional grids, the increases contact area should not have a significant impact on fuel rod loading. The increased contact area allows the grid height to be reduced, thus reducing the volume of grid material in the active core, resulting in less neutron absorption in the core. Further, the larger subchannel flow area than conventional grids provides room for future subchannel inserts to enhance coolant mixing, heat transfer and departure from nucleate boiling (DNB) performance.

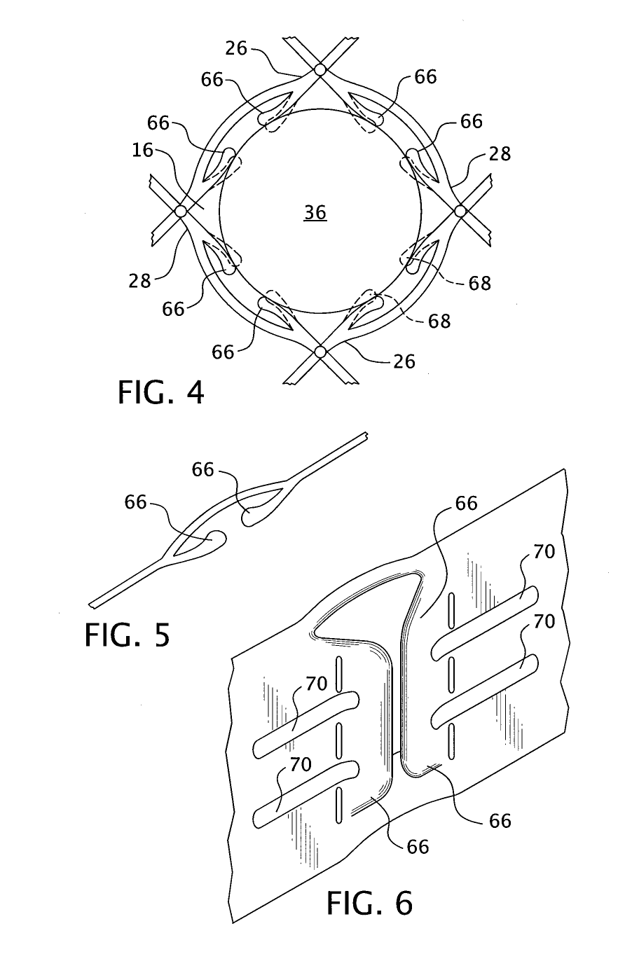

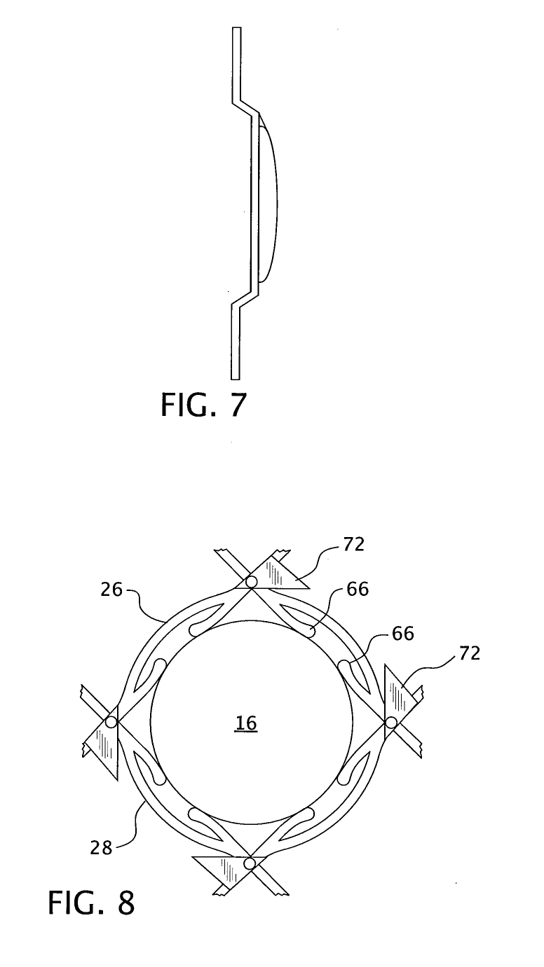

An alternate embodiment to that shown in FIG. 2 that reduces the spring pressure per unit area of fuel rod cladding surface contact, but which enhances coolant contact with the cladding, is illustrated in FIG. 4. The embodiment of this invention illustrated in FIG. 4 uses the diagonal pitch wavy strap configuration illustrated in FIG. 2 without the hard dimples to support the fuel rods previously employed by the prior art, but includes eight appropriately shaped cantilevered springs 66 on each rod cell 16. Each of the cantilevered springs two per cell wall, provides a large line of contact with the rod 36 to provide a high total force on the rod, but low per unit area contact pressure that produces compliant rod supports throughout the life of the fuel assembly. The low contact pressure is not enough to cause generalized removal of the oxide layer by abrasion, even when due to dimensional changes or small relative movement between the rod 36 and the support points on the springs 66. The symmetric and identical structure of the springs 66 on each of the walls of the cells 16 simplifies manufacture. Plan, side and elevational vies of one side of a fuel rod support cell 16 are respectively shown in FIG. 5, 6, and 7 and provide a between view of the two cantilevered springs 66 per side in their undeflected state. The shape of the springs 66 is such that when a uniform pressure is applied corresponding to the contact pressure with the rod, the spring surface is in theoretical contact with the rod along a vertical line parallel to the axis of the rod 36. This requires that the undeflected spring is slightly curved along its length, as can be best viewed from FIG. 7. Conventional grids typically exert a fore on the rod cladding surface of between 2-19 lbs. Because the contact area of the springs in this embodiment is large compared to conventional springs, the force that will be exerted by the springs of this invention will be in the low end of this range.

The spring area, when rod 36 contact takes place, is bent around a vertical bend line along the full length of the spring and away from the surface of the rod 36 so that the rod is in contact with two essentially convex surfaces per side defining two narrow lines of contact. The spring in its compressed form is shown in solid lines in FIG. 4, with the uncompressed contour being outlined in phantom. The leading edge of the spring 66 is further bent away around a horizontal bend line which along with the vertical bend line form a three-dimensional curved quasi-spherical surface that can best be appreciated from the elevational view shown in FIG. 6 and the side view shown in FIG. 7. The bend of the leading edge is to minimize rod scratches during rod loading. To control the stiffness of the springs 66, bathtub-shaped, shallow indentations 70 are stamped along a length of each spring on the straps 26 and 28. The number of dimensions of the indentations 70 provide means to vary the overall spring 66 stiffness to achieve optimum support and vertical slits may be provided if necessary to stiffness.

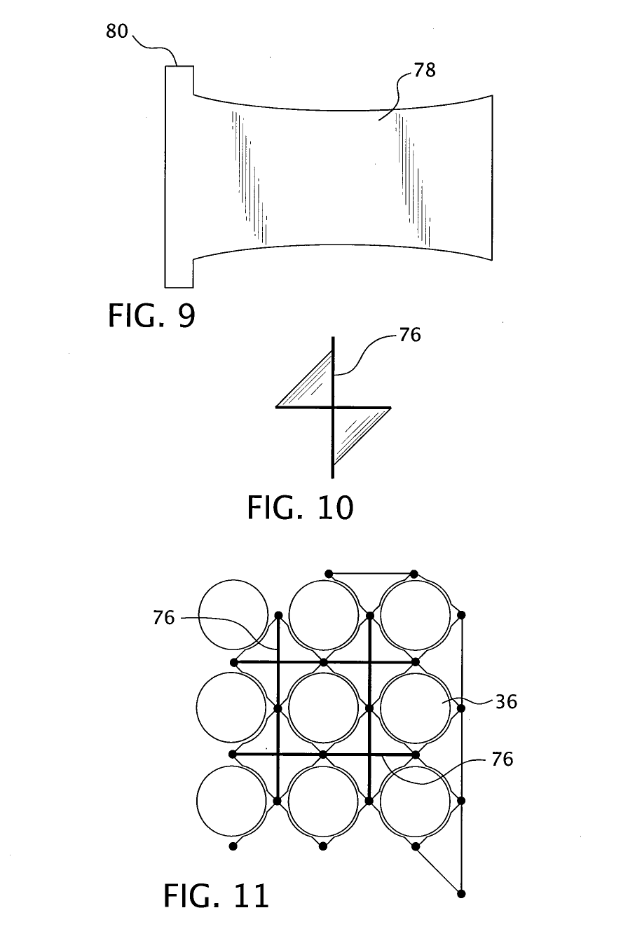

In another embodiment, conventional mixing vanes 72 can be used around each fuel rod cell 16, as illustrated in FIG. 8. Each mixing vane can have a small hole 74 to permit access to weld the intersection of the straps 26 and 28, if the vane 72 is located directly above the intersection. In additional to or instead of conventional mixing vanes 72, the diagonal pitch strap configuration of this invention allows the insertion of additional mixing devices, such as twisted ribbon inserts 72 shown in FIG. 10, inside the open cells between rods 36, as shown in FIG. 11. The twisted ribbon inserts 76 are formed from planer straps, such as the strip 78 illustrated in FIG. 9, with transversely extending weld tabs 80 on either side of one end. The strap is then twisted by an appropriate angle, e.g., 90°, along its longitudinal axis. The strap 78 is specifically sized before twisting, so that the dimensions after twisting are compatible with the inside dimension of a grid cell. The ribbons are welded in place inside the vacant grid cells at the location of the weld tabs 80. The twisted ribbon imparts a rotational movement to the coolant, sending cooler water towards the surface of the rods 36. In order to avoid a net torque on the grid, the number of ribbons with clockwise and counterclockwise rotation within one assembly should be the same and preferably, the same in each quadrant.

In addition to enhanced mixing, the inserts also increase locally the hydraulic resistance and they tend to direct the flow to adjacent subchannels. The ribbon inserts 76 could be located in the vicinity of the limiting rods, i.e., the hottest rods, to locally enhance coolant mixing and direct additional flow to the limiting rods 36, thus further enhancing DNB performance. The decision where to use the twisted ribbon inserts 76 can be made without hardware tooling constraints, therefore given the ability to optimize designs without completely retooling to fabricate a new grid. Accordingly, it is not essential to have twisted ribbon inserts in each of the empty cells between rods.

While specific embodiments of the invention have been described in detail, it will be appreciated by those skilled in the art that various modifications and alternatives to those details could be developed in light of the overall teachings of the disclosure. For example, while the preferred embodiment is directed to an improved grid for a pressurized water reactor fuel assembly, the principles of this invention could be applied to a boiling water reactor as well. Accordingly, the particular embodiments disclosed are meant to be illustrative only and not limiting as to the scope of the invention which is to be given the full breadth of the appended claims and any and all equivalents thereof.

What is claimed is:

1. A nuclear fuel assembly grid comprising:
a first plurality of spaced, parallel, elongated straps curved in an undulating wave pattern along an axial length of the first plurality of elongated straps;
a second plurality of spaced, parallel, elongated straps curved in an undulating wave pattern along an axial length of the second plurality of elongated straps, said second plurality of spaced, parallel, elongated straps are positioned orthogonal to said first plurality of spaced, parallel, elongated straps and aligned in a regular pattern so that the intersection of each set of four straps defines a cell, some of which support fuel rods; and
a bordering strap surrounding the first and second plurality of spaced, parallel, elongated straps, wherein the first and second plurality of spaced, parallel, elongated straps are on a diagonal with respect to the bordering strap.

2. The nuclear fuel assembly grid of claim 1 wherein the first and second plurality of elongated straps are aligned so that all the undulations bordering each cell either curve toward the center of the cell or all curve away from the center of the cell.

3. The nuclear fuel assembly grid of claim 2 wherein a plurality of the cells that have bordering undulations curving away from the center of the cell support fuel rods.

4. The nuclear fuel assembly grid of claim 3 wherein a radius of curvature of the undulations is larger than a radius of curvature of the fuel rods.

5. The nuclear fuel assembly grid of claim 1 wherein a bottom or top of at least one of the straps bordering a cell supporting at least one of the fuel rods is splayed to promote coolant mixing.

6. The nuclear fuel assembly of claim 1 wherein a portion of all of the elongated straps bordering at least one of the cells supporting the fuel rod has no raised dimples or springs.

7. The nuclear fuel assembly of claim 6 wherein the portion of all of the elongated straps bordering all of the cells supporting the fuel elements have no raised dimples or springs.

8. The nuclear fuel assembly grid of claim 1 wherein there is an adjacent cell next to every cell supporting fuel rods that is empty and in which the unobstructed flow of coolant can occur.

9. The nuclear fuel assembly grid of claim 1 wherein the cells that support the fuel rods have a spring on each wall that extend into the cell.

10. The nuclear fuel assembly grid of claim 9 wherein the springs are cantilevered from the cell walls and extend into the cell.

11. The nuclear fuel assembly grid of claim 10 wherein the springs extend along the elongated dimension respectively of the first and second plurality of straps.

12. The nuclear fuel assembly grid of claim 11 wherein the cells that support fuel rods have two juxtaposed cantilevered springs on each wall.

13. The nuclear fuel assembly grid of claim 12 wherein a shape of each spring is such that when a uniform pressure is applied corresponding to a contact pressure with the fuel rod, the spring surface is in contact with the rod along a vertical line parallel to an axis of the fuel rod.

14. The nuclear fuel assembly grid of claim 13 wherein the undeflected shape of each spring facing an interior of the cell is curved.

15. The nuclear fuel assembly grid of claim 13 wherein the spring area where the fuel rod contact takes place is bent around a vertical bend line, along the full length of the spring and away from a surface of the rod so that the rod is in contact with two essentially convex surfaces per cell side wall defining two narrow line of contact.

16. The nuclear fuel assembly grid of claim 15 wherein a leading edge of each spring is bent away around a horizontal bend line, which along with the vertical bend line form a three dimensional curved, quasi spherical surface.

17. The nuclear fuel assembly grid of claim 12 wherein the juxtaposed springs on each wall of the cells that support fuel rods are the same shape and are positioned the same as the springs on the other walls of the cell.

18. The nuclear fuel assembly grid of claim 10 wherein the springs have shallow grooves that enhance their stiffness.

19. The nuclear fuel assembly grid of claim 1 wherein there is an adjacent cell next to every cell supporting fuel rods that is devoid of rods and wherein at least some of the cells devoid of rods have a flow deflector supported herein.

20. The nuclear fuel assembly grid of claim 19 wherein the flow deflector is a ribbon vane.

21. The nuclear fuel assembly grid of claim 20 wherein the ribbon vane has an axis parallel to an axis of the fuel rod and a 90 degree twist.

22. A nuclear fuel assembly having a spacer grid comprising:
a first plurality of spaced, parallel, elongated straps curved in an undulating wave pattern along an axial length of the first plurality of elongated straps;
a second plurality of spaced, parallel, elongated straps curved in an undulating wave pattern along an axial length of the second plurality of elongated straps, said second plurality of spaced, parallel, elongated straps are positioned orthogonal to said first plurality of spaced, parallel, elongated straps and aligned in a regular pattern so that the intersection of each set of four straps defines a cell, some of which support fuel rods; and
a bordering strap surrounding the first and second plurality of spaced, parallel, elongated straps, wherein the first and second plurality of spaced, parallel, elongated straps are on a diagonal with respect to the bordering strap.

23. The nuclear fuel assembly of claim 22 wherein the first and second plurality of elongated straps are aligned so that all the undulations bordering each cell either curve toward the center of the cell or all curve away from the center of the cell.

24. The nuclear fuel assembly grid of claim 23 wherein a plurality of the cells that have bordering undulations curving away from the center of the cell support fuel rods.

25. The nuclear fuel assembly grid of claim 24 wherein a radius of curvature of the undulations is larger than a radius of curvature of the fuel rods.

26. The nuclear fuel assembly grid of claim 22 wherein a bottom or top of at least one of the straps bordering a cell supporting at least one of the fuel rods is splayed to promote coolant mixing.

27. The nuclear fuel assembly of claim 22 wherein a portion of substantially all of the elongated straps bordering all of the cells supporting the fuel elements have no raised dimples or springs.

28. The nuclear fuel assembly grid of claim 22 wherein there is an adjacent cell next to every cell supporting fuel rods that is empty and in which the unobstructed flow of coolant can occur.

29. The nuclear fuel assembly grid of claim 1 wherein the cells that support the fuel rods have a spring on each wall that extend into the cell.

30. The nuclear fuel assembly grid of claim 29 wherein the springs are cantilevered from the cell walls and extend into the cell.

31. The nuclear fuel assembly grid of claim 30 wherein the springs extend along the elongated dimension respectively of the first and second plurality of straps.

32. The nuclear fuel assembly grid of claim 31 wherein the cells that support fuel rods have two juxtaposed cantilevered springs on each wall.

33. The nuclear fuel assembly grid of claim 32 wherein a shape of each spring is such that when a uniform pressure is applied corresponding to a contact pressure with the fuel rod, the spring surface is in contact with the rod along a vertical line parallel to an axis of the fuel rod.

34. The nuclear fuel assembly grid of claim 33 wherein the undeflected shape of each spring facing an interior of the cell is curved.

35. The nuclear fuel assembly grid of claim 33 wherein the spring area where the fuel rod contact takes place is bent around a vertical bend line, along the full length of the spring and away from a surface of the rod so that the rod is in contact with two essentially convex surfaces per cell side wall defining two narrow line of contact.

36. The nuclear fuel assembly grid of claim 35 wherein a leading edge of each spring is bent away around a horizontal bend line, which along with the vertical bend line form a three dimensional curved, quasi spherical surface.

37. The nuclear fuel assembly grid of claim 32 wherein the juxtaposed springs on each wall of the cells that support fuel rods are the same shape and are positioned the same as the springs on the other walls of the cell.

38. The nuclear fuel assembly grid of claim 30 wherein the springs have shallow grooves that enhance their stiffness.

39. The nuclear fuel assembly grid of claim 22 wherein there is an adjacent cell next to every cell supporting fuel rods that is devoid of rods and wherein at least some of the cells devoid of rods have a flow deflector supported herein.

40. The nuclear fuel assembly grid of claim 39 wherein the flow deflector is a ribbon vane.

41. The nuclear fuel assembly grid of claim 40 wherein the ribbon vane has an axis parallel to an axis of the fuel rod and a 90 degree twist.
